(19) United States
(12) Patent Application Publication
(10) Pub. No.: US 2014/0358683 A1
(43) Pub. Date: Dec. 4, 2014

(54) Method of generating revenue from promoters utilizing wireless technology

(71) Applicant: John A. Panicali, Colts Neck, NJ (US)

(72) Inventor: John A. Panicali, Colts Neck, NJ (US)

(21) Appl. No.: 13/986,726

(22) Filed: May 29, 2013

(51) Int. Cl. G06Q 30/02

(52) U.S. Cl. CPC G06Q 30/0267; G06Q 30/0257
USPC 705/14.55

(57) ABSTRACT

A method of generating revenue from promoters utilizing wireless technology includes: a wireless communications devices app that permits reading a unique printed bar code that is sent to a host device. The host device software matches the code to a unique video, which is sent back to the wireless communications device for instant playing. The promoter of the video purchases services to store the code and the video for app use.

### BACKGROUND OF INVENTION

1. Field of Invention

The invention relates generally to downloadable applications, commonly referred to as “apps” or “mobile apps”, for wireless communications devices (“WCD”), that enable promoters to offer additional promotional information via a video sent to a portable WCD when the user of that WCD scans a printed code, such as a universal product code or other code presented or available to the user in print form, such as codes on fliers, business cards, on products, product packaging, product inserts and product advertising, or similarly for social cards, services advertising or other printed documents. The user shoots the code (“scans” it), through the cell phone or PDA or other WCD camera, and it is received by the app and sent to a host device. The host device transmits the promoter's corresponding video back to the user's WCD and it is played instantly.

2. Description of Related Art

The following patents and applications are representative of various types of high hat devices:

U.S. Pat. No. 8,290,522 B2 to Lapstun et al. describes a method of sending a message using a business card with data encoded on a surface, and a mobile phone. The data includes an identifier which uniquely identifies the surface and the mobile telephone senses the coded data to determine the identifier. Using the identifier, the phone retrieves a representation of the business card, which has a plurality of fields, one of which being a messaging field. The business card is displayed on the phone such that the messaging field can be user selected, a message generated and transmitted to a communications address retrieved from a database.

U.S. Pat. No. 8,270,955 B2 to Ramer et al. describes a system and computer-implemented method for positioning targeted sponsored content on a mobile communication facility that includes the steps of (a) receiving data corresponding to a transaction event having been conducted by a user and correlating the user with their associated mobile communication facility, wherein the transaction event includes transmission of data representative of a first set of products or services having been purchased by the user; (b) selecting advertising content based at least upon a relevance between an advertisement for a second product or a second service and the purchased first set of products or services in the transaction event, wherein the relevance is further based on information relating to compatibility of the advertising content, second product, or second service with the mobile communication facility; and (c) presenting the selected advertising content on a display of the mobile communication facility.

U.S. Pat. No. 8,209,344 B2 to Ramer et al. describes a method and system for distribution of advertising of sponsored content within an application of a mobile communication facility, wherein selection of the sponsored content is based at least on one or more predefined hardware or software characteristics of the mobile communication facility.

U.S. Pat. No. 8,195,133 B2 to Ramer et al. describes a method and system for receiving a navigation request from a mobile communication facility, receiving an indicator input, receiving a business rule relating to handling a mobile content type, dynamically creating a content based at least in part on an association of the navigation request, the indicator input and the business rule, and presenting the dynamically created content to the mobile communication facility.

U.S. Pat. No. 8,131,737 to Ramer et al. B2 describes a computer-implemented method for positioning targeted sponsored content on a cellular phone that includes the steps of (a) assessing a likelihood of an interaction by a user of the cellular phone with a sponsored content, wherein the assessment is based on a plurality of user characteristics associated with the cellular phone, such as a user profile and a predefined hardware/software characteristic; (b) prioritizing the placement of the sponsored content within one of a plurality of predefined areas of a graphical user interface of the cellular phone over the placement of other sponsored content within the same area, wherein the prioritization is based on the assessment of the likelihood of the interaction of the user of the cellular phone with the sponsored content; and (c) presenting the sponsored content within the one of a plurality of predefined areas of the graphical user interface of the cellular phone.

U.S. Pat. No. 8,131,585 B2 to Nicholas et al. describes a telecommunication system that implements a method for providing a targeted on-line advertisement to a user accessing a content provider node of the system. The system further comprises an ad selection node and an user identification node. A user signal indicative of an information request is routed through the system to determine a geographic location of the user and/or a demographic profile of the geographic location. An advertiser corresponding to the geographic location and/or demographic profile is thereafter communicated to the user.

U.S. Pat. No. 8,116,813 B2 to Silverbrook et al. describes a system of retrieving a product using a print medium with a print media identifier linked to a product. A mobile telecommunications device with a sensor module for determines the print media identifier from the print medium such that the product is retrieved using the mobile telecommunications device and the print media identifier. The print medium is provided with first coded data in a first format and second coded data in a second format. The first coded data encodes first information and the second coded data encodes second information. The first information is indicative of the print media identifier and of size and orientation data of the print medium. The first format is a linear pattern. At least some of the second information is indicative of the print media identifier and a two-dimensional coordinate grid. The second format is a two-dimensional pattern, the first and second coded data each being encoded in a plurality of tags printed on the print medium. Each tag has a structure that includes a target and the first and second coded data. The targets are sensed by the sensor module to determine the presence of the tags.

U.S. Pat. No. 8,081,994 B2 to Lapstun et al. describes a method of sending a message using a print medium is disclosed. Coded data on a surface of the business card is sensed by a sensor module in a media feed path of a communications device. The coded data encodes an identifier which uniquely identifies the surface. The identifier is determined from sensed coded data, and a representation of the business card is retrieved using the identifier. The representation of the business card is displayed on display of the communications device, with the representation including fields, with one of the fields being a messaging field. Upon receiving a selection of the messaging field, a communications address is retrieved from a database where the communications address is indexed by the identifier. A message editor is opened in the communications device, with a current message being addressed to the communications address.

U.S. Pat. No. 8,041,717 B2 to Ramer et al. describes improved mobile advertisement syndication capabilities disclosed for mobile communications facilities, such as cell phones. These and other capabilities are employed to improve delivery of mobile advertisements and their syndication, such as associating advertising content with websites, to appropriate or desirable mobile communication facilities.

U.S. Pat. No. 7,945,943 B2 to Silverbrook et al. describes a method of gaining access to a resource using an access token linked to a print medium, comprising the steps of: determining a print media identifier from the print medium using a sensor module of a mobile telecommunications device, the print media identifier having been linked to the access token; identifying, using the mobile telecommunications device and the print media identifier, the access token; and, causing the access token to be supplied to a system, wherein the system is configured to authenticate the access token and, if the authentication succeeds, provide access to the resource.

U.S. Pat. No. 7,925,299 B2 to Lapstun et al. describes a method of sending a message using a print medium. A tag on a surface of the print medium is sensed using a sensor module. The surface includes a plurality of tags with each tag encoding an identifier which uniquely identifies the surface and a position with respect to the surface. From the tag sensed by the sensor module the identifier and the position with respect to the surface of the tag sensed by the sensor module are determined. A communications address is obtained, using the identifier and the position, from a database where the communications address is indexed by the identifier and the position. A message editor in a communications device is then opened, with a current message being addressed to the communications address.

U.S. Pat. No. 7,907,968 to Silverbrook et al. describes a method of retrieving contact details using a print medium. Data encoded on a surface of the print medium is sensed using a sensor module. The sensed data encodes a print media identifier which uniquely identifies the print medium, and a two-dimensional position with respect to the surface of the print medium. The print media identifier and the position of the sensor module relative to the surface of the print medium are determined from the sensed data. Contact details referenced by the print media identifier and the position of the sensor module are then retrieved from a database.

U.S. Pat. No. 7,894,703 B2 to Lapstun et al. describes a method of retrieving video data using a print medium, comprising the steps of: determining a print media identifier from the print medium using a sensor module of a mobile telecommunications device, the print media identifier having been linked to the video data; and, retrieving, using the mobile telecommunications device, the video data.

U.S. Pat. No. 7,127,261 B2 to Van Erlach describes methods and platforms for providing enhanced telecommunication wireless and wireline services comprising: 1) wireless device location-based personal contact service; 2) digital multi-media telecommunication session documentation; 3) provision of digital product samples according to subscriber-definable criteria and to a wireless device upon reading of a product identifying code with a wireless device; 4) wireless location-based product price, availability and information service; 5) short-range wireless device CRM (customer relationship management) functions; 6) wireless vital sign monitoring service capable of automatic messaging; 7) entertainment event futures determination method and securities market. The invention is physically comprised of a telecommunication platform such as a web-enabled computer, television or other device; or a telephone, cell phone, or wireless PDA that integrates some or all of: a computing apparatus, a digital camera, a data input method from external wireless devices, a network interface capable of interfacing with the Internet and/or a telecommunications network such as a public telephone network, a short-range wireless communication method with other wireless devices, such as Bluetooth, a user interface, a bar code or other product code (such as RFID) reading apparatus and software, a global positioning system (GPS) or other device location determination method, a network service provider and related application hosting facilities, software and databases.

United States Patent App. No. US 2005/0245271 A1 to Vesuna describes a system and method for providing enriched content over a wireless network to a mobile device based on location information read by the mobile device from a location information storage device. The location information storage device may be a bar code, RFID tag, Infobutton, or any other device which may be affixed to a fixed location and which may store unique location information to be read by the mobile device.

United States Patent App. No. US 2005/0203854 A1 to Das et al. describes a method of facilitating a transaction between a camera-phone user and a business entity. The business entity produces a printed medium indicating a transaction. The printed medium includes a barcode that includes direct contact data for communicating with the business entity. The barcode further includes specific transaction data relating to the transaction in the printed medium. Using the digital camera feature, the user captures a digital image of the barcode. The camera-phone is programmed to decode the digital image to retrieve the direct contact data and the transaction data embedded in the barcode. The camera-phone then automatically initiates a direct communication with the business entity via the mobile communications device using the decoded direct contact data. Once communications are established, the camera phone further transmits the transaction data derived from the barcode to further facilitate the transaction. The barcode includes an encrypted digital signature that can be used by the camera-phone to authenticate the identity of the business entity that created the printed medium

Notwithstanding the prior art, the present invention is neither taught nor rendered obvious thereby.

### SUMMARY OF INVENTION

The present invention is directed to a method of generating revenue from promoters utilizing wireless technology. The method includes the following: a) providing a video promotion application to a plurality of wireless communications devices, and providing a host device, said promotion application including a touch icon to activate said promotion application and subsequent means for reading a printed code, and including wireless communication with said host device, to transmit a reading of said printed code to said host device from at least one of said plurality of wireless communications devices to activate a no-click transmission from said host device to at least one of said plurality of wireless communications devices, and to immediately play a unique video associated with said printed code back to said at least one of said plurality of wireless communications devices; b) providing a promotion website for third party promoters to establish an account and to input a printed code and a corresponding unique video that is unique to that code, said website having sufficient software to provide the following steps: (i) enabling third party promoters to establish a payment account wherein said third party promoters must make a payment before proceeding to subsequent steps set forth below; (ii) enabling a third party promoter who has made a payment on an account to establish a unique code corresponding to said third party promoter and storing said code with said host device; (iii) enabling said third party promoter to download a unique promotional video and linking said video to said unique code and hosting said video and code on said host device; wherein a wireless communications device user may choose said free application, take a reading of a printed code and said corresponding unique video will automatically display and play on said wireless communications device.

In some embodiments of the present invention method of generating revenue from promoters utilizing wireless technology, the unique video presentation is selected from the group consisting of product information, product safety information, product usage information, product accessory information and combinations thereof.

In some embodiments of the present invention method of generating revenue from promoters utilizing wireless technology, the unique video presentation is selected from the group consisting of a person profile, a business profile, a goods catalog, a services catalog and combinations thereof.

In some embodiments of the present invention method of generating revenue from promoters utilizing wireless technology, the printed code is a printed code selected from the group consisting of a product package code, a business card code, and a printed promotional document code.

In some embodiments of the present invention method of generating revenue from promoters utilizing wireless technology, the printed code is a universal price code.

In some embodiments of the present invention method of generating revenue from promoters utilizing wireless technology, the printed code is a preset code established by the promoter before entering the promotion website and said website includes means to receive a download of said code and link it to a corresponding unique video.

In some embodiments of the present invention method of generating revenue from promoters utilizing wireless technology, the promotion website further includes means to store a preset collection of codes and to sell individual codes to promoters and to link them with unique videos.

In some embodiments of the present invention method of generating revenue from promoters utilizing wireless technology, the free promotion application includes means to prohibit storage of a unique video transmission.

In some embodiments of the present invention method of generating revenue from promoters utilizing wireless technology, the free promotion application includes means to permit storage of a unique video transmission.

In some embodiments of the present invention method of generating revenue from promoters utilizing wireless technology, the promotion website further includes sufficient software for the following step: (iv) enable said third party promoters to select an option to permit storage or prohibit storage of transmitted videos.

A method of generating revenue from promoters utilizing wireless technology, which comprises: a) providing a video promotion application to a plurality of wireless communications devices, and providing a host device, said promotion application including a touch icon to activate said promotion application and subsequent means for reading a printed code, and including wireless communication with said host device, to transmit a reading of said printed code to said host device from at least one of said plurality of wireless communications devices to activate a no-click transmission from said host device to at least one of said plurality of wireless communications devices, and to immediately play a unique video associated with said printed code back to said at least one of said plurality of wireless communications devices; b) providing a promotion website for third party promoters to establish an account and to input a printed code and a corresponding unique video that is unique to that code, said website having sufficient software to provide the following steps: (i) enabling third party promoters to establish a payment account wherein said third party promoters must make a payment before proceeding to subsequent steps set forth below; (ii) enabling a third party promoter who has made a payment on an account to establish a unique code corresponding to said third party promoter and storing said code with said host device; (iii) enabling said third party promoter to download a unique promotional video and linking said video to said unique code and hosting said video and code on said host device; (iv) enabling said third party promoters to elect to provide contact information for download and storage at unique video receiving wireless communications devices; wherein a wireless communications device user may choose said free application, take a reading of a printed code and said corresponding unique video will automatically display and play on said wireless communications device; and further wherein said wireless communications devices user may opt to save any contact information received with said unique video.

In some embodiments of the present invention method of generating revenue from promoters utilizing wireless technology that includes contact information options for the promoter, the unique video presentation is selected from the group consisting of product information, product safety information, product usage information, product accessory information and combinations thereof.

In some embodiments of the present invention method of generating revenue from promoters utilizing wireless technology that includes contact information options for the promoter, the unique video presentation is selected from the group consisting of a person profile, a business profile, a goods catalog, a services catalog and combinations thereof.

In some embodiments of the present invention method of generating revenue from promoters utilizing wireless technology that includes contact information options for the promoter, the printed code is a printed code selected from the group consisting of a product package code, a business card code, and a printed promotional document code.

In some embodiments of the present invention method of generating revenue from promoters utilizing wireless technology that includes contact information options for the promoter, the printed code is a universal product code.

In some embodiments of the present invention method of generating revenue from promoters utilizing wireless technology that includes contact information options for the promoter, the printed code is a preset code established by the promoter before entering the promotion website and said website includes means to receive a download of said code and link it to a corresponding unique video.

In some embodiments of the present invention method of generating revenue from promoters utilizing wireless technology that includes contact information options for the promoter, the promotion website further includes means to store a preset collection of codes and to sell individual codes to promoters and to link them with unique videos.

In some embodiments of the present invention method of generating revenue from promoters utilizing wireless technology that includes contact information options for the promoter, the free promotion application includes means to prohibit storage of a unique video transmission.

In some embodiments of the present invention method of generating revenue from promoters utilizing wireless technology that includes contact information options for the promoter, the free promotion application includes means to permit storage of a unique video transmission.

In some embodiments of the present invention method of generating revenue from promoters utilizing wireless technology that includes contact information options for the promoter, the promotion website further includes sufficient software for the following step: (v) enable said third party promoters to select an option to permit storage or prohibit storage of transmitted videos.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagram of various embodiments of the present invention method, showing the overall steps involved by the promoters of promotional videos and the users of the apps to generate a playing of such a video by reading a unique code linked to the video;

FIG. 2 is a front view of a website “Home” page that is exemplary of a website that may be used in the present invention method to sign up promoters, to collect fees, to create or receive or sell a unique codes and to receive and link promotional videos to their unique codes for subsequent functionalities in the method;

FIG. 3 is a front view of the exemplary present invention website of FIG. 2, but showing the “How To Use Site” page;

FIG. 4 is front view of the exemplary present invention website of FIG. 2, but showing the options page for Promoters who have an account and have logged in;

FIG. 5 is a front view of different exemplary present invention website that provides services for video recipients;

FIG. 6 is a front view of one embodiment of a present invention method, showing a cell phone and block diagram features from a user's perspective;

FIG. 7 is a front view of the exemplary present invention website of FIG. 2, but showing an optional “Categories” page; and,

FIG. 8 is a front view of a block diagram listing optional but important features that may be offered to subscribing promoters.

### DETAILED DESCRIPTION OF THE EMBODIMENTS

The invention relates generally to downloadable applications, commonly referred to as “apps”, for wireless communications devices (“WCD”) that enable promoters to offer additional promotional information via a video sent to a portable WCD when the user of that WCD scans a printed code. The printed code may be any known or created code, such as a universal product code, bar code, QR code or other code. The code is presented or available to the user in print form, such as codes on fliers, business cards, on products, product packaging, product inserts and product advertising, or similarly for social cards, services promotions, advertising or other printed documents. The user shoots the code (“scans” it), through the cell phone or PDA or other WCD camera or scanner, and it is received by the app and sent to a host device. The host device transmits the promoter's corresponding video back to the user's WCD and it is played instantly. The term “scan” as used herein is broadly meant to include laser or other light scanning as well as photographing digitally with the WCD.

The present invention method of generating revenue from promoters includes two separate approach mechanisms, the promoter approach and the user approach. One is to enable a promoter to create an account and to pay for the services related to that account whereby a promoter creates, inputs, transfers or purchases a unique code, such as a barcode, a QR code, universal product code, or other code that is linked to a unique promotional video provided by the promoter. The other is to enable portable wireless communications device users to download an app and subsequently use the app to scan a promoter's printed unique code, causing immediate transmission and playing of the corresponding video back to the scanning WCD.

Among the many types of promotional videos that may be included in the present invention method are product information videos that provide customers, users and purchasers of particular products with more detailed information about those products, such as product descriptions, specifications, warranties, cautions or other manufacturers information. Product safety information may be included in the promotional video. For example, the present invention method could be used to provide alternative or additional warnings and side-effects for medicines, or safety information for power equipment, electrical devices or other products where safety may be important. Consider also that artists, restaurants, shops, online sales and services, artisans, craftspeople, and many others with one-of-a-kind works (think of paintings, sculptures, songs and dances) or accomplishments or capabilities will be able to use the present invention method to promote as they desire, by the mere shooting of their unique codes, in their presence or out of their presence. Gyms and therapy services can display videos showing their facilities at work and/or include references or testimonials, show various pieces of equipment in use, or focus on a single piece of equipment with instructions on proper use. Music videos, amateur or professional, may be received and show in full or in part to promote CD sales, concerts or other commercial endeavors. The uses are broad and deep, from professions offering health care services, to the toddler's party clown who wants to show 30 seconds of his “joy”. This will become more fully evident with the following discussion of the Figures:

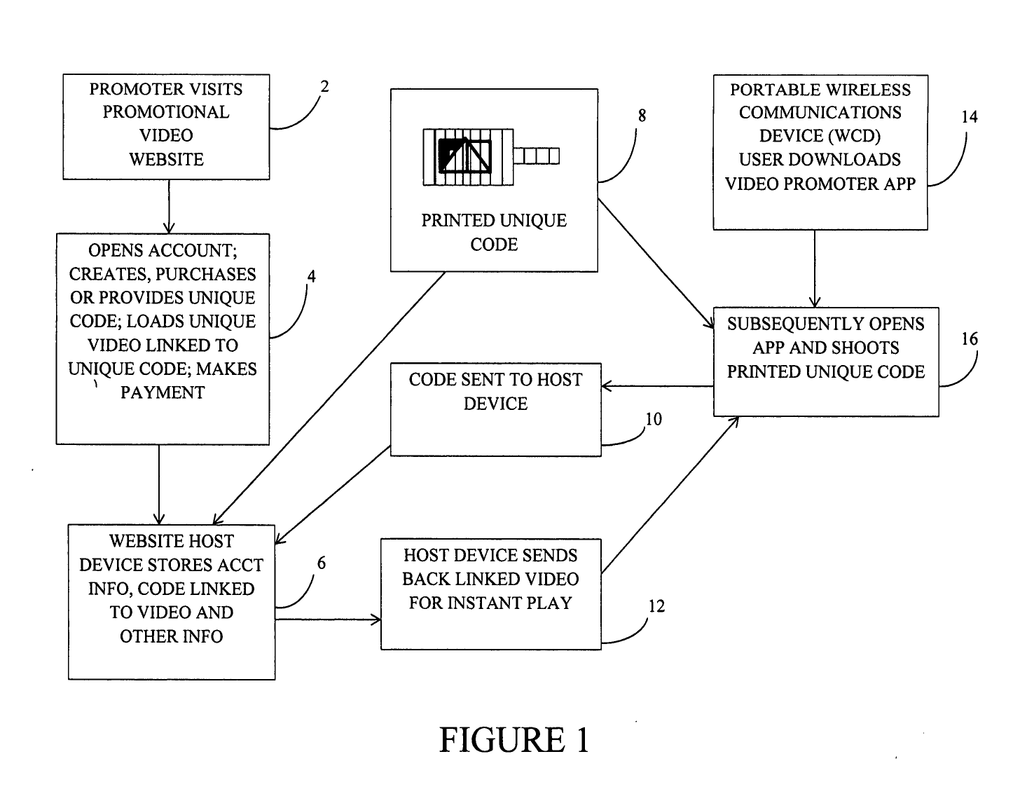

FIG. 1 is a block diagram of various embodiments of the present invention method, showing the overall steps involved by the promoters of promotional videos and the users of the apps to generate a playing of such a video by reading a unique code linked to the video. The process in chronological order as follows:

The owner/creator of the method first creates a website on a host device. The host device is a physical device with adequate internet website hosting capabilities necessary to support and perform internet functions, including storing, reading, processing, isolating of data, including informational, financial and digit video, accounts data, credit card and similar processing and other backroom capabilities that are now well known in ecommerce and well within the skills of the artisan. Thus, the host device is either a computer or a group of computers functionally connected to one another, and is in possession/control of the creator, or in possession or control of a hosting service or part of a cloud service, that includes the foregoing capabilities. The website has software to support the following features: promoter secure log in; account set up including promoter personal and financial data; receiving unique codes from promoters; storing the codes; receiving videos from the promoters and linking them (tying them into a bundle wherein each code is associated with a video); and offering and processing other services as discussed in conjunction with all of the Figures set forth below.

Either through the same website or another website, or a third party services provider, the creator establishes an application (“app”) source and functionality for WCD users. The app may be downloaded by any user who chooses to do so, typically as a free or minimal cost service, preferably as a free download. In some embodiments, the free downloads may also include offers for various options, e.g., upgrades, saves, forwards, etc. for a small charge. The app source sends an app icon along with whatever software is necessary to enable the WCD user with the app downloaded: (a) to scan a printed code, which code is digitally in the promoters website; (b) to send the digital data equivalent of the printed code to the website (where the website recognizes the incoming digital code data, and the website takes the corresponding (linked) video and sends it back to the user for instant play); and (c) to receive and play the receiving video; and (d) to provide other optional steps, such as saving, forwarding, taking contact info, and other options that are discussed below.

Thus, in FIG. 1, the promoter visits the promotional video website, block 2, and opens an account, gets or gives a unique code, downloads a video that attached to the code, and pays the fees for the service, not necessarily in that order, block 4. For example, other steps may be included along the way as the promoter completes the account, such as options discussed below. The website stores the bundle of the promoter's code and corresponding video and other necessary and optional information, block 6. A potable wireless communications device user downloads the video promoter app, block 14. When presented with or finding a promoter app printed unique code, block 8, the user subsequently may scan the code, block 16. The code is automatically transmitted back to the host device, block 10. In turn, the host device sends the video that is linked with (corresponds to) the received code back to the user's WDC for instant play of the video, block 12.

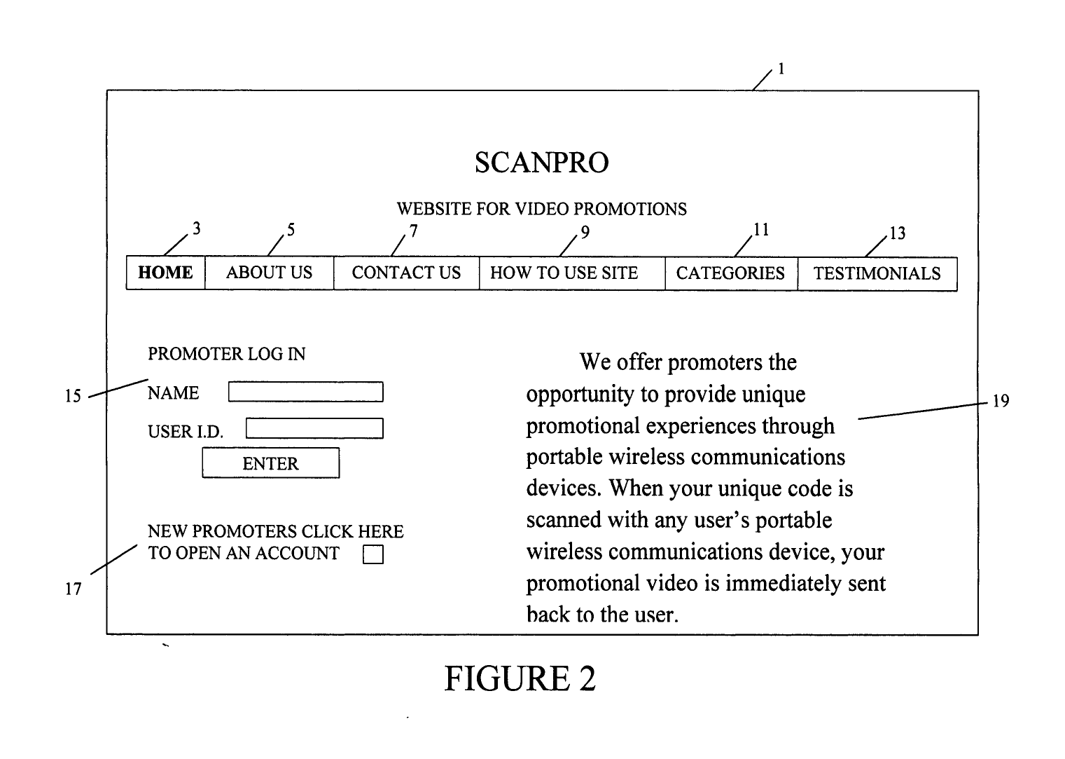

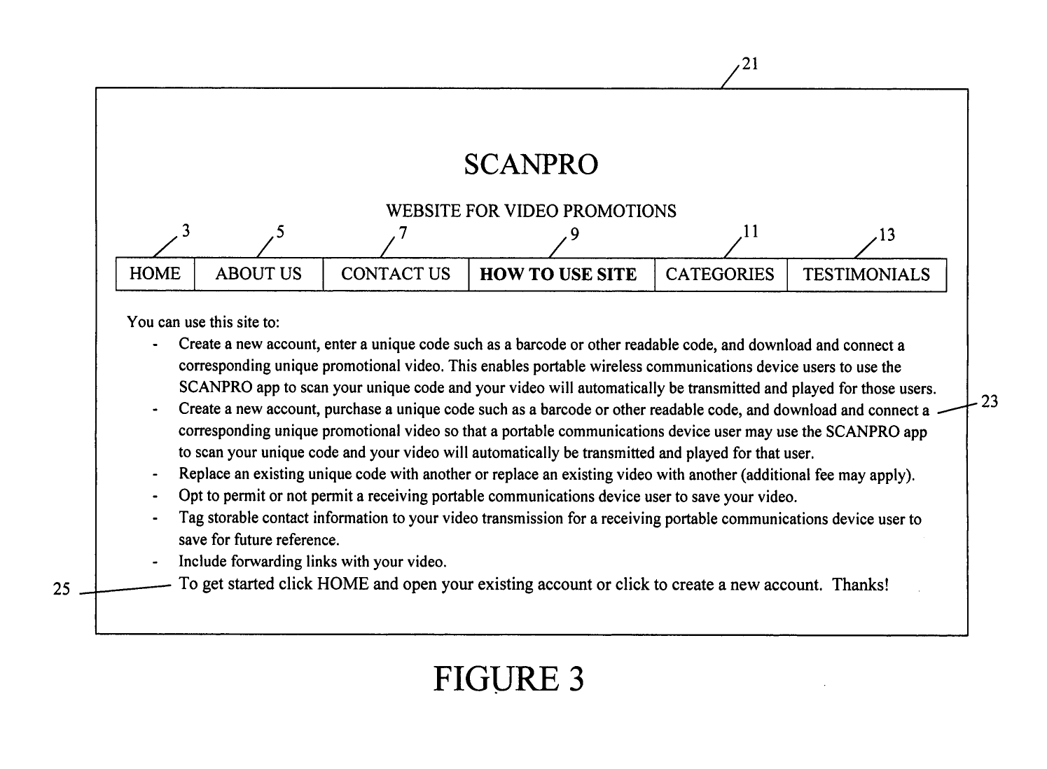

FIG. 2 is a front view of a website “Home” page 1 of a website (e.g., SCANPRO, a fictional name for purposes of illustration) that may be used in the present invention method to sign up promoters, to collect fees, to create or receive or sell a unique codes and to receive and link promotional videos to their unique codes for subsequent functionalities in the present invention method. This page has many icons, such as HOME bar 3, ABOUT US bar 5, CONTACT US bar 7, HOW TO USE SITE bar 9, CATEGORIES bar 11, TESTIMONIALS bar 13, as well as a promoter log in name and user i.d. boxes for existing accounts 15, and new promoter's check in to open a new account 17. There is also a text area 19 for a brief message, promotion, explanation or other information. A site visitor may click on any choice presented, such as bar 9. This page is further developed in FIG. 3.

FIG. 3 is a front view of the exemplary present invention website 1 of FIG. 2, but showing the “How To Use Site” page 21. Page 21 includes the various bars described above, as well as a description 23 of how the site may be used. There is an invitation 25 to return to the HOME page to open an existing or new account.

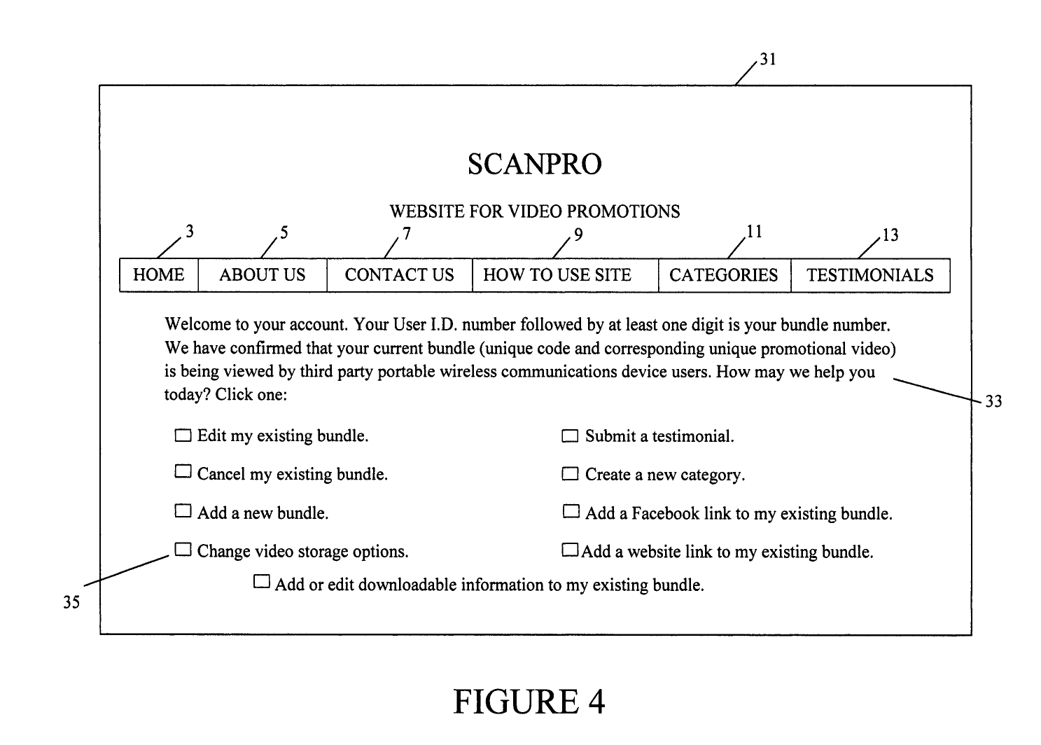

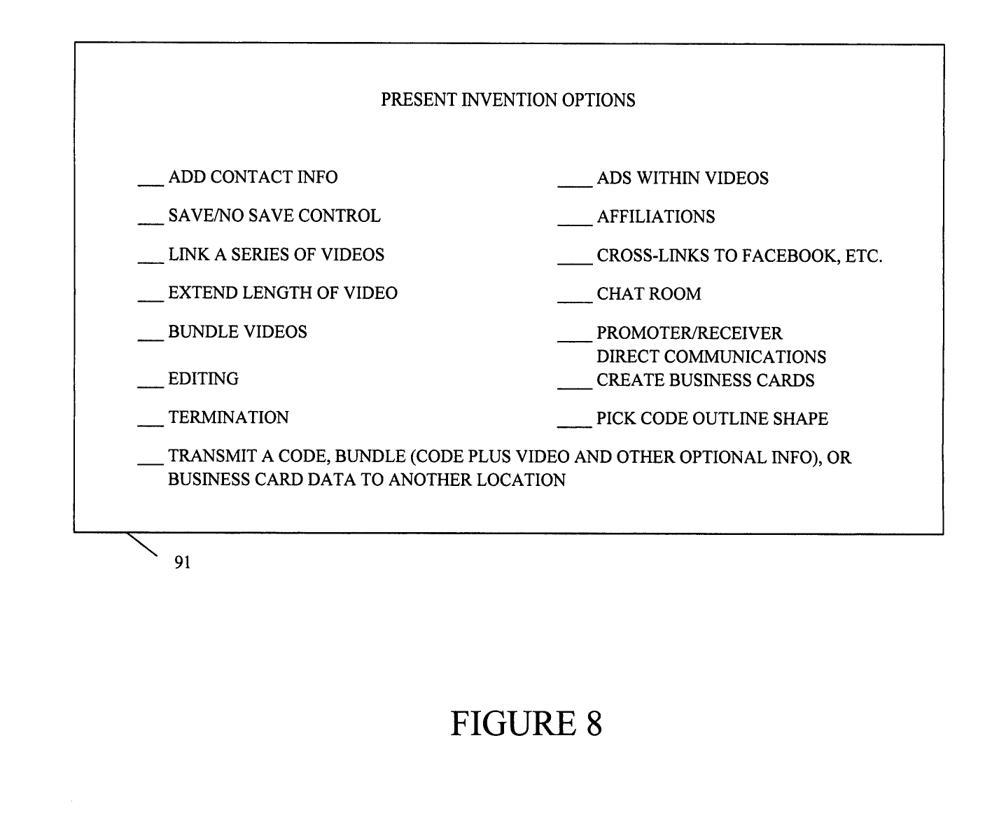

FIG. 4 is front view of the exemplary present invention website 1 of FIG. 2, but showing the promoters options page 31 for Promoters who have an account and have logged in. There is an introduction and informational paragraph 33 along with a number of choices 35 that a promoter may select and a subsequent page will open for detailed steps to accomplish the selected option. The choices 35 include: edit my existing bundle; cancel my existing bundle; add a new bundle; change video storage options; add or edit downloadable information to my existing bundle; submit a testimonial; create a new category; add a Facebook link to my existing bundle; add a website link to my existing bundle. Many other options may be included as suggested, for example, in FIG. 8 below.

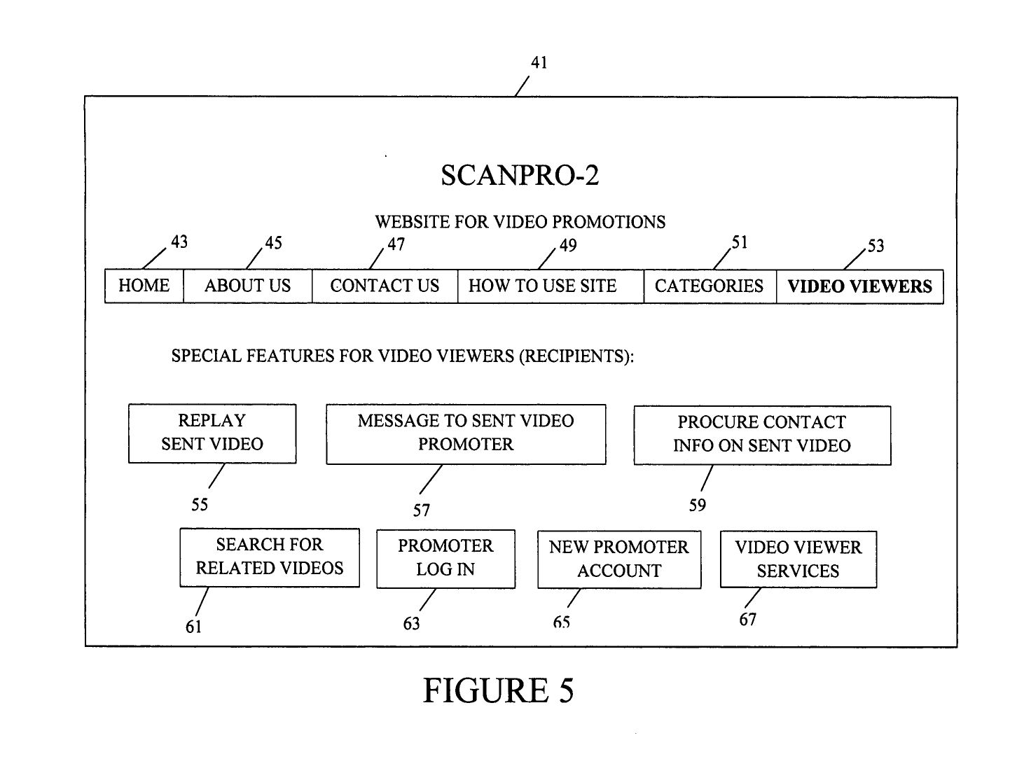

FIG. 5 is a front view of different exemplary present invention website 41 that provides services for video recipients. This page includes general icon bars as follows: HOME bar 43, ABOUT US bar 45, CONTACT US bar 47, HOW TO USE SITE bar 49, CATEGORIES bar 51, VIDEO VIEWERS bar 53, as well as Special Feature bars to provide video viewer options. These Special Feature bars include: REPLAY SENT VIDEO bar 55, MESSAGE TO SENT VIDEO PROMOTER bar 57, PROCURE CONTACT INFO ON SENT VIDEO bar 59, SEARCH FOR RELATED VIDEO bar 61, PROMOTER LOG IN bar 63, NEW PROMOTER ACCOUNT bar 65, VIDEO VIEWER SERVICES bar 67

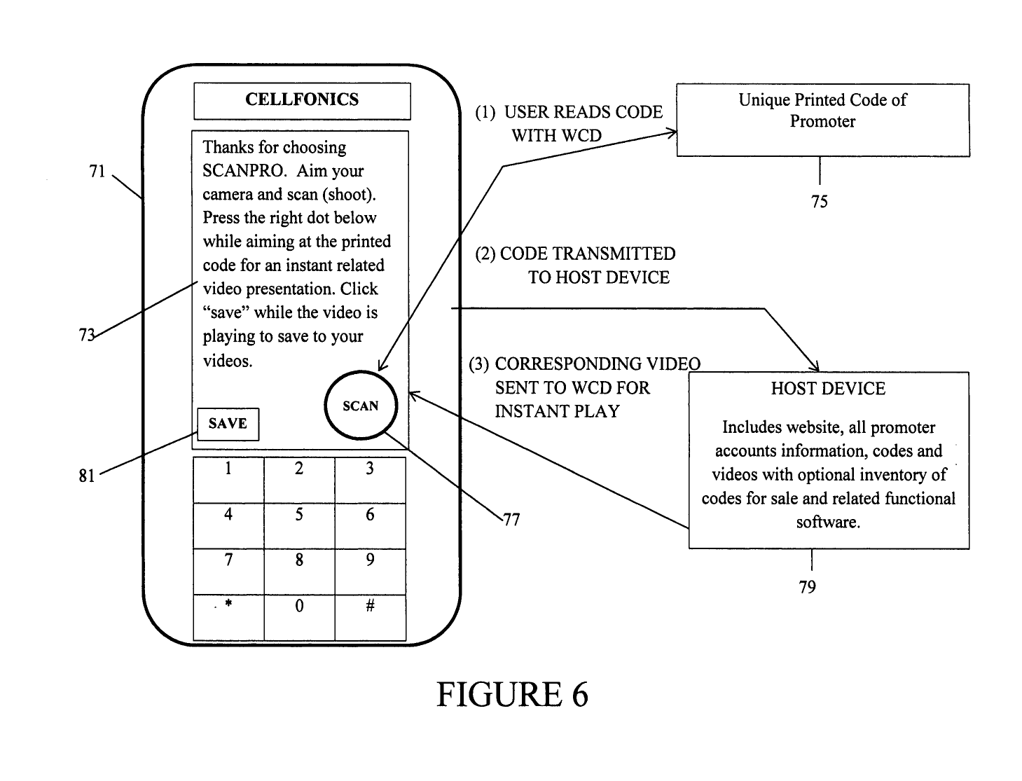

FIG. 6 is a front view of one embodiment of a present invention method, showing a cell phone 71 and block diagram features from a user's perspective. In this Figure, the cell phone user has already downloaded the app and has, according to this Figure, selected the app for use. In other words, FIG. 6 shows the cell phone after the user has pressed the app icon of the previously downloaded app. The screen that appears has a message 73 and an optional SCAN button 77 and optional SAVE button 81. The SCAN button 77 is optional because many PDA's today may be focused on a code and will automatically SCAN a code without clicking or pressing a button. Thus, the app may have the SCAN button 77 appear when there is no auto-scan feature and not appear when there is an auto-scan feature. The SAVE button 81 may be included in the download if the promoter who created the bundle and purchased the service opts to allow saving the video. Also, although not shown, optional forwarding features may be included so that the viewer may share the video with others wirelessly. The three steps are numbered in order in the Figure, as follows: (1) USER READS CODE WITH WCD. Unique printed code 75 is read, in this case, by the user pressing SCAN button 77 (because no auto-scan is available). The printed code is taken in and translated into digital data, which is automatically wirelessly transmitted to host device 79. Hence, step (2) CODE TRANSMITTED TO HOST DEVICE, is accomplished. Host device 79 matches the code data with its corresponding video and step (3) CORRESPONDING VIDEO SENT TO WCD FOR INSTANT PLAY is accomplished. The video may be accompanied by other information or features, such as links or contact information of the promoter. In some preferred embodiments where the SCAN button is needed, variations of the foregoing are possible: the SCAN button may appear only as a see-through so as to not impede viewing of the video; likewise, a SAVE icon might only appear after a code is read, or even only at the end of the video play.

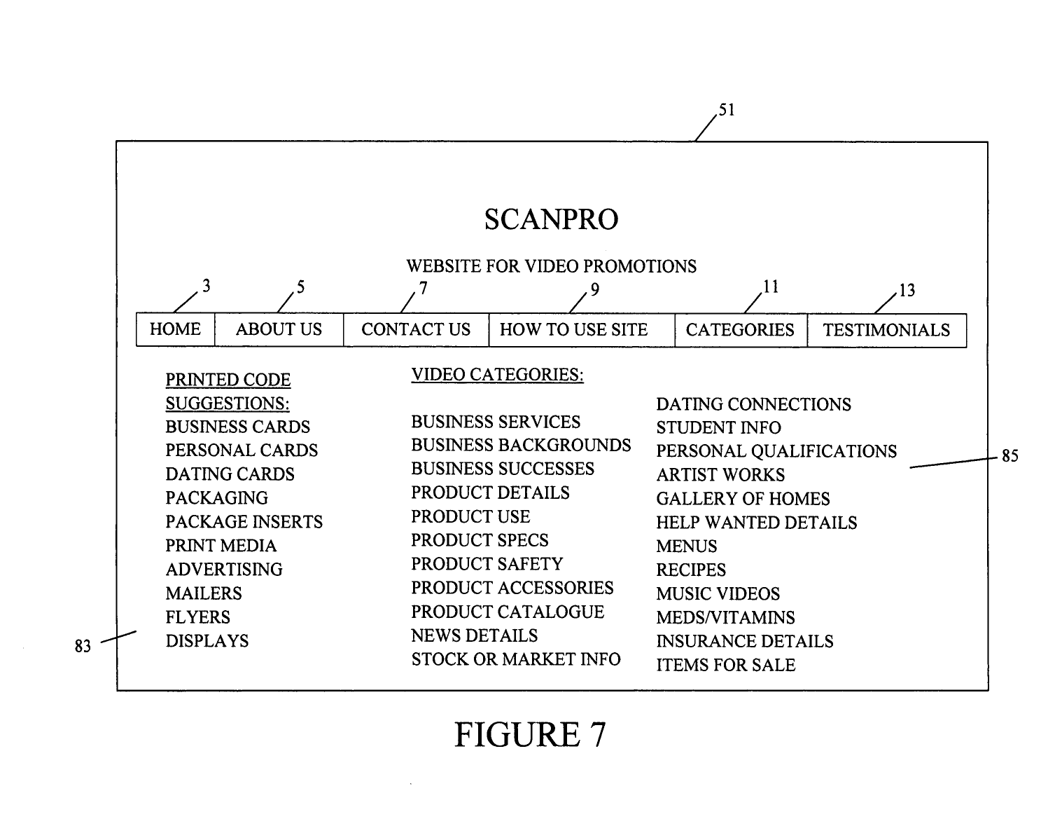

FIG. 7 is a front view of the exemplary present invention website of FIG. 2, but showing an optional “Categories” page 51. In addition to the categories list 85, there is also a printed code suggestions list for the placement of the unique printed code of the promoter. These include cards, newspapers, packaging, mailers, etc. There is no limit as to where these may appear in printed form, ranging from elaborate codes on poker chips to personal code tattoos. However, it is anticipated that more conventional uses will become prevalent. For example, imagine a florist that uses a flower outline with a code on it on every business card, advertisement and mailer, and attached to a message on every floral delivery, and that florist business will blossom. The categories list 85 includes: business services, business backgrounds, business successes, product details, product use, product specs, products safety, product accessories, product catalogue, news details, stock or market info, dating connections, student info, personal qualifications, artist works, gallery of homes, help wanted details, menus, recipes, music videos, meds/vitamins, insurance details, items for sale. Many other categories can be envisioned . . . any type of business or social activity may lend itself to an adaptation of the present invention method.

FIG. 8 is a front view of a block diagram 91 listing optional but important features that may be offered to subscribing promoters. These include the options listed, and could include a page that would open, for example, on code outline shapes, showing numerous code outline selections—a house outline for realtors, a framing for artists, a cross or other religious shape for religious purposes, a dog for kennels and pet supplies, etc. Even customized shapes could be used, such as for non-profits, e.g., Boy Scouts.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A method of generating revenue from promoters utilizing wireless technology, which comprises:
a) providing a video promotion application to a plurality of wireless communications devices, and providing a host device, said promotion application including a touch icon to activate said promotion application and subsequent means for reading a printed code, and including wireless communication with said host device, to transmit a reading of said printed code to said host device from at least one of said plurality of wireless communications devices to activate a no-click transmission from said host device to at least one of said plurality of wireless communications devices, and to immediately play a unique video associated with said printed code back to said at least one of said plurality of wireless communications devices;
b) providing a promotion website for third party promoters to establish an account and to input a printed code and a corresponding unique video that is unique to that code, said website having sufficient software to provide the following steps:
(i) enabling third party promoters to establish a payment account wherein said third party promoters must make a payment before proceeding to subsequent steps set forth below;
(ii) enabling a third party promoter who has made a payment on an account to establish a unique code corresponding to said third party promoter and storing said code with said host device;
(iii) enabling said third party promoter to download a unique promotional video and linking said video to said unique code and hosting said video and code on said host device;
wherein a wireless communications device user may choose said free application, take a reading of a printed code and said corresponding unique video will automatically display and play on said wireless communications device.

2. The method of generating revenue from promoters utilizing wireless technology of claim 1, wherein said unique video presentation is selected from the group consisting of product information, product safety information, product usage information, product accessory information and combinations thereof.

3. The method of generating revenue from promoters utilizing wireless technology of claim 1, wherein said unique video presentation is selected from the group consisting of a person profile, a business profile, a goods catalog, a services catalog and combinations thereof.

4. The method of generating revenue from promoters utilizing wireless technology of claim 1, wherein said printed code is a printed code selected from the group consisting of a product package code, a business card code, and a printed promotional document code.

5. The method of generating revenue from promoters utilizing wireless technology of claim 1, wherein said printed code is a universal product code.

6. The method of generating revenue from promoters utilizing wireless technology of claim 1, wherein said printed code is a preset code established by the promoter before entering the promotion website and said website includes means to receive a download of said code and link it to a corresponding unique video.

7. The method of generating revenue from promoters utilizing wireless technology of claim 1, wherein said promotion website further includes means to store a preset collection of codes and to sell individual codes to promoters and to link them with unique videos.

8. The method of generating revenue from promoters utilizing wireless technology of claim 1, wherein said free promotion application includes means to prohibit storage of a unique video transmission.

9. The method of generating revenue from promoters utilizing wireless technology of claim 1, wherein said free promotion application includes means to permit storage of a unique video transmission.

10. The method of generating revenue from promoters utilizing wireless technology of claim 1, wherein said promotion website further includes sufficient software for the following step:
(iv) enable said third party promoters to select an option to permit storage or prohibit storage of transmitted videos.

11. A method of generating revenue from promoters utilizing wireless technology, which comprises:
a) providing a video promotion application to a plurality of wireless communications devices, and providing a host device, said promotion application including a touch icon to activate said promotion application and subsequent means for reading a printed code, and including wireless communication with said host device, to transmit a reading of said printed code to said host device from at least one of said plurality of wireless communications devices to activate a no-click transmission from said host device to at least one of said plurality of wireless communications devices, and to immediately play a unique video associated with said printed code back to said at least one of said plurality of wireless communications devices;
b) providing a promotion website for third party promoters to establish an account and to input a printed code and a corresponding unique video that is unique to that code, said website having sufficient software to provide the following steps:
(i) enabling third party promoters to establish a payment account wherein said third party promoters must make a payment before proceeding to subsequent steps set forth below;
(ii) enabling a third party promoter who has made a payment on an account to establish a unique code corresponding to said third party promoter and storing said code with said host device;
(iii) enabling said third party promoter to download a unique promotional video and linking said video to said unique code and hosting said video and code on said host device;
(iv) enabling said third party promoters to elect to provide contact information for download and storage at unique video receiving wireless communications devices;
wherein a wireless communications device user may choose said free application, take a reading of a printed code and said corresponding unique video will automatically display and play on said wireless communications device; and further wherein said wireless communications devices user may opt to save any contact information received with said unique video.

12. The method of generating revenue from promoters utilizing wireless technology of claim 11, wherein said unique video presentation is selected from the group consisting of product information, product safety information, product usage information, product accessory information and combinations thereof.

13. The method of generating revenue from promoters utilizing wireless technology of claim 11, wherein said unique video presentation is selected from the group consisting of a person profile, a business profile, a goods catalog, a services catalog and combinations thereof.

14. The method of generating revenue from promoters utilizing wireless technology of claim 11, wherein said printed code is a printed code selected from the group consisting of a product package code, a business card code, and a printed promotional document code.

15. The method of generating revenue from promoters utilizing wireless technology of claim 11, wherein said printed code is a universal product code.

16. The method of generating revenue from promoters utilizing wireless technology of claim 11, wherein said printed code is a preset code established by the promoter before entering the promotion website and said website includes means to receive a download of said code and link it to a corresponding unique video.

17. The method of generating revenue from promoters utilizing wireless technology of claim 11, wherein said promotion website further includes means to store a preset collection of codes and to sell individual codes to promoters and to link them with unique videos.

18. The method of generating revenue from promoters utilizing wireless technology of claim 11, wherein said free promotion application includes means to prohibit storage of a unique video transmission.

19. The method of generating revenue from promoters utilizing wireless technology of claim 11, wherein said free promotion application includes means to permit storage of a unique video transmission.

20. The method of generating revenue from promoters utilizing wireless technology of claim 11, wherein said promotion website further includes sufficient software for the following step:
(v) enable said third party promoters to select an option to permit storage or prohibit storage of transmitted videos.
